(19) United States
(12) Patent Application Publication
(10) Pub. No.: US 2013/0319924 A1
(43) Pub. Date: Dec. 5, 2013

(54) ASYMMETRIC ePTFE MEMBRANE

(71) Applicants: Yit-Hong Tee, Lee's Summit, MO (US); Vishal Bansal, Overland Park, KS (US); Christopher Keller, Overland Park, KS (US)

(72) Inventors: Yit-Hong Tee, Lee's Summit, MO (US); Vishal Bansal, Overland Park, KS (US); Christopher Keller, Overland Park, KS (US)

(73) Assignee: General Electric Company, Schenectady, NY (US)

(21) Appl. No.: 13/488,682

(22) Filed: Jun. 5, 2012

(51) Int. Cl. B01D 71/42; B01D 67/00; B01D 61/36; B01D 71/00; B01D 71/06

(52) U.S. Cl. 210/180; 210/500.21; 210/500.27; 210/500.35; 427/244; 427/535

(57) ABSTRACT

A membrane distillation system is provided for distilling liquids. The membrane distillation system includes a heat generating means for heating a non-distilled liquid. The membrane distillation system further includes a microporous membrane that is asymmetric and vapor permeable. The microporous membrane includes a hydrophilic layer and a hydrophobic layer. The membrane distillation system further includes a supply means for delivering the heated non-distilled liquid to the hydrophilic layer of the microporous membrane. A collection means is further provided for collecting distilled liquid from the hydrophobic layer of the microporous membrane. A method of fabricating the microporous membrane for use in the membrane distillation system is also provided.

### BACKGROUND OF THE INVENTION

1. Field of the Invention

The present invention relates generally to liquid distillation, and more particularly, to liquid distillation utilizing an asymmetric expanded polytetrafluoroethylene (ePTFE) membrane.

2. Discussion of the Prior Art

Vapor-permeable, liquid-impermeable microporous membranes are known and used in many different applications. Such microporous membranes are used, for example, in membrane distillation systems for distilling liquids. In short summary, the membrane distillation system can incorporate waste heat for heating a non-distilled liquid, whereupon the heated non-distilled liquid is delivered to the microporous membrane. Vapor from the non-distilled liquid passes through the microporous membrane, with the vapor then condensing into a distilled liquid. In the past, completely hydrophobic membranes have been used in such membrane distillation systems. Similarly, boundary layers are provided on one or more surfaces of the hydrophobic membrane to improve resistance to fouling. However, diffusion through these completely hydrophobic membranes having boundary layers is relatively slow, as the vapor must first pass through the boundary layers and then permeate through the completely hydrophobic membrane. A completely hydrophobic membrane in the membrane distillation system exhibits less than desirable water vapor permeation flux, such as in a range of about 5-60 l/m²/hr, and is prone to fouling through wetting of internal pores. Accordingly, it would be useful to provide a membrane distillation system with a microporous membrane having an increased water vapor permeation flux and an improved resistance to fouling.

### BRIEF DESCRIPTION OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect, the present invention provides a membrane distillation system for distilling liquids. The membrane distillation system includes a heat generating means for heating a non-distilled liquid. The membrane distillation system further includes a microporous membrane that is asymmetric and vapor permeable, wherein the microporous membrane including a hydrophilic layer and a hydrophobic layer. The membrane distillation system further includes a supply means for delivering the heated non-distilled liquid to the hydrophilic layer of the microporous membrane and a collection means for collecting distilled liquid from the hydrophobic layer of the microporous membrane.

In accordance with another aspect, the present invention provides a microporous membrane that is vapor permeable for distilling liquids. The membrane includes a hydrophilic layer provided at a first side of the microporous membrane. The microporous membrane further includes a hydrophobic layer provided at an opposing second side of the microporous membrane. The first side of the microporous membrane is asymmetric with respect to the second side of the microporous membrane.

In accordance with another aspect, the present invention provides a method of fabricating a microporous membrane that is vapor permeable for use in a membrane distillation system. The method includes the step of providing a hydrophobic microporous membrane. The method further includes the step of treating a first side of the hydrophobic microporous membrane with energetic sources and coating the first side with hydrophilic moieties to covalently bond the hydrophilic moieties to the first side. As such, the first side of the hydrophobic microporous membrane is hydrophilic and a second side is hydrophobic.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is schematized illustration of an example membrane distillation system in accordance with an aspect of the present invention;

FIG. 2 is a schematized view of an example microporous membrane for use in the membrane distillation system of FIG. 1, the microporous membrane having a hydrophilic layer that is asymmetric to an opposing hydrophobic layer;

FIG. 3 is an enlarged, schematic view of a portion of the microporous membrane within the membrane distillation system of FIG. 1 and shows open microscopic porosity defined by fibrils connected at nodes; and

FIG. 4 is a further enlarged view of a portion of FIG. 3 and shows constituent members of the microporous membrane that include a substrate, with a hydrophilic moiety coating adhered to the substrate that does not block the pores of the microporous membrane.

### DETAILED DESCRIPTION OF THE INVENTION

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

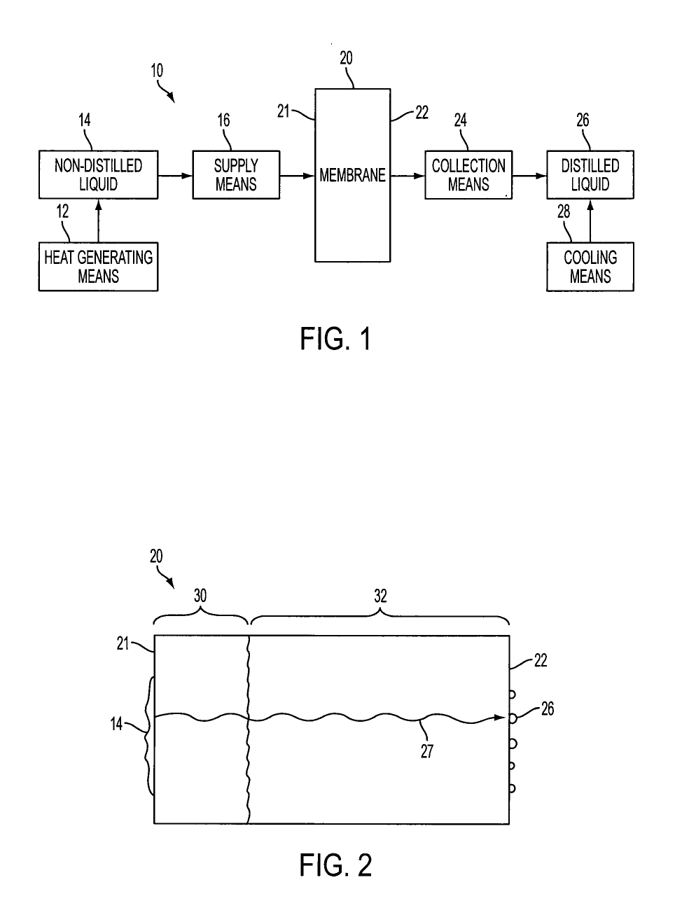

FIG. 1 illustrates a schematized view of an example membrane distillation system 10 in accordance with one aspect of the present invention. In brief synopsis, the membrane distillation system 10 includes a microporous membrane 20 that filters a non-distilled liquid 14 into a distilled liquid 26. The microporous membrane 20 can include a first side 21 (FIG. 2), including a hydrophilic layer 30, and an opposing second side 22, including a hydrophobic layer 32. The non-distilled liquid 14 is delivered to the first side 21 of the microporous membrane 20, whereupon vapor from the non-distilled liquid 14 passes through the hydrophilic layer and through the hydrophobic layer to the second side 22. The vapor will then condense into the distilled liquid 26. As will be described in detail below, the microporous membrane 20 is asymmetric by having the hydrophilic layer 30 on one side and the hydrophobic layer 32 on the opposing side. By being asymmetric, the microporous membrane 20 exhibits an increased water permeation flux and resistance to fouling.

It is to be appreciated that the membrane distillation system 10 of FIG. 1 is somewhat generically/schematically depicted for illustrative purposes. The membrane distillation system 10 can be used in a number of industrial applications. Industrial applications can include, but are not limited to, the separation of contaminants from one or more liquids, such as for water purification. In another example, the membrane distillation system 10 can be used in a number of locations that have excess waste heat from industrial processes including, but not limited to, factories, hot springs, solar energy locations, or the like. It is to be appreciated that the membrane distillation system 10 could be implemented in other locations as well, such as in power plants, nuclear reactors, etc.

The membrane distillation system 10 includes a heat generating means 12. The heat generating means 12 is schematically depicted in FIG. 1, as the heat generating means 12 can include a number of different structures. The heat generating means 12 maintains the non-distilled liquid 14 at a relatively high temperature. The heat generating means 12 can include, for example, waste heat, low grade heat, or the like that is generated from the above mentioned industrial process. In one example, the heat generating means 12 could include waste heat from a power plant, solar energy, geothermal energy, or the like. Of course, it is to be appreciated that the heat generating means 12 is not limited to the aforementioned examples, and can include any nearly any type of structure or process that produces heat to warm the non-distilled liquid 14. In further examples, the heat generating means 12 is not limited to waste heat, and could also include a variety of structures that produce heat, such as burners, boilers, heat exchangers, or the like.

The membrane distillation system 10 further includes the non-distilled liquid 14. The non-distilled liquid 14 is heated by the heat generating means 12. The non-distilled liquid 14 can include any number of different liquids. For example, the non-distilled liquid 14 could include non-distilled and/or impure liquids such as seawater, brackish water, freshwater, or nearly any other type of contaminated/non-filtered water. In further examples, the non-distilled liquid 14 is not limited to a fluid (e.g., water), but may include combinations of liquid and solids, such as semi-solid liquids, or the like. Indeed, the non-distilled liquid 14 could include a number of different liquids or semi-solid liquids that may contain an undesired substance including, but not limited to, solutes, dissolved gases, salts, particulates, etc. The non-distilled liquid 14 can be located near the industrial process. For example, the non-distilled liquid 14 can be found in a nearby body of water such as an ocean, lake, pond, swamp, etc. As is generally known, the non-distilled liquid 14 could be contained in a storage means, such as a tank, reservoir, etc.

The membrane distillation system 10 further includes a supply means 16 for supplying the non-distilled liquid 14 to the microporous membrane 20. The supply means 16 is somewhat generically depicted in FIG. 1, as the supply means 16 can include a number of different structures that function to deliver the non-distilled liquid 14 to the microporous membrane 20. For example, the supply means 16 can include any number of different pipes, tubes, pumps, and/or other apparatuses that can be used to transport liquid from one location to another. In further examples, the supply means 16 could also include valves, flow meters, or the like for controlling the rate of flow of the non-distilled liquid 14 to the microporous membrane 20. A holding tank or container (not shown) may be provided in fluid communication with the supply means 16 such that the non-distilled liquid 14 can flow into the holding tank from the piping, tubing or other apparatus prior to reaching the microporous membrane 20. Of course, it is to be appreciated that the supply means 16 can include any combination of the above-mentioned items for supplying the non-distilled liquid 14 to the microporous membrane 20.

The membrane distillation system 10 further includes the microporous membrane 20. In general, the microporous membrane 20 can include a vapor permeable-liquid impermeable membrane that separates two bodies of liquid, wherein each body is maintained at a different temperature (e.g., a temperature gradient). This temperature gradient across the microporous membrane 20 creates a vapor pressure differential between the first side 21 (e.g., adjacent the non-distilled liquid 14) and the opposing second side 22. The temperature difference between the first side 21 and second side 22 of the microporous membrane 20 can convey a pressure difference, which allows the vapor at the first side 21 to permeate through the microporous membrane 20 and condense at the cooler second side 22. As such, the vapor can pass through the microporous membrane 20 and produce a net pure liquid flux from the warmer first side 21 to the cooler second side 22 of the microporous membrane 20. The membrane distillation process across the microporous membrane 20 can be described in three basic steps. First, the non-distilled liquid 14 is maintained at a higher temperature to evaporate it as it reaches the first side 21 of the microporous membrane 20. Second, the vapor permeates through the microporous membrane 20. Lastly, condensation can occur when the vapor exits the second side 22 of the microporous membrane 20.

The membrane distillation system 10 can further include a collection means 24 for collecting the distilled liquid 26 from the second side 22 of the microporous membrane 20. The collection means 22, shown generically/schematically in FIG. 1, can include similar and/or identical structures and apparatuses as the supply means 16. For example, the collection means 22 may include pipes, tubes, pumps, and/or other apparatus(es) that can be used to collect and/or transport the distilled liquid 26 from one location (e.g., the second side 22 of the microporous membrane 20) to another. Similarly, the collection means 22 could also include valves, flow meters, or the like for controlling the rate of flow of the distilled liquid 26 from the microporous membrane 20. In one example, the collection means 22 includes a holding tank or container (not shown) into which the distilled liquid 26 flows before being transported away with the tubing, piping, etc. Of course, it is to be appreciated that the collection means 22 can include any combination of the above mentioned items for collecting the distilled liquid 26.

The membrane distillation system 10 can further include a cooling means 28 for maintaining the distilled liquid 26 at a temperature that is lower than the non-distilled liquid 14. By maintaining the distilled liquid 26 at a lower temperature, the temperature gradient is formed across the microporous membrane 20. This temperature gradient can drive the transport of vapor through the microporous membrane 20. In one example, the temperature of the ambient air at the second side 22 is below that of the temperature of the non-distilled liquid 14 being supplied to the first side 21 of the microporous membrane 20, such that the cooling means 28 can include ambient air. In other examples, the cooling means 28 includes structures and/or devices that can lower the temperature of the distilled liquid 26. For example, the cooling means 28 can include condensers, refrigerants, heat exchangers, or the like. In further examples, even if the ambient temperature is lower than the temperature of the non-distilled liquid 14, the cooling means 28 may nonetheless be provided to create a temperature gradient sufficient to cause a net flux of distilled liquid 26 across the microporous membrane 20.

Referring to FIG. 2, the microporous membrane 20 can now be described in more detail. It is to be appreciated that the microporous membrane 20 shown in FIG. 2 is somewhat generically depicted for illustrative purposes. Indeed, in further examples, the microporous membrane 20 could have a larger or smaller cross-sectional width than as shown. Accordingly, the microporous membrane 20 depicted in FIG. 2 includes only one possible example, as the microporous membrane 20 could include a variety of different dimensions.

The microporous membrane 20 can include any number of different hydrophobic materials that are vapor permeable and liquid impermeable. In one example, the microporous membrane 20 can include expanded polytetrafluoroethylene (ePTFE). However, in further examples, the microporous membrane 20 could include other microporous materials that repel liquid while allowing for the passage of vapor therethrough. The microporous membrane 20 could further include polytetrafluoroethylene (eTFE), polyvinylidene fluoride (PVDF), polypropylene (PP), etc. As such, it is to be appreciated that the microporous membrane 20 is not limited to the examples listed herein, and could include other hydrophobic materials.

The microporous membrane 20 extends between the first side 21 and the opposing second side 22. The first side 21 is positioned adjacent the non-distilled liquid side of the membrane distillation system 10 while the second side 22 is positioned adjacent the distilled liquid side. The first side 21 can receive the non-distilled liquid 14 (shown generically as a pooled liquid formation in FIG. 2). Similarly, the distilled liquid 26 can be collected from the second side 22 (shown generically as droplets of liquid in FIG. 2). Of course, it is to be appreciated that the non-distilled liquid 14 and distilled liquid 26 in FIG. 2 are generically depicted for illustrative purposes, and in further examples, could each include more liquid or less liquid than as shown.

The microporous membrane 20 can be treated to render a portion of the microporous membrane 20 hydrophilic. In one example, the first side 21 of the microporous membrane 20 is treated and can be rendered hydrophilic while the second side 22 of the microporous membrane 20 remains hydrophobic. As such, a portion of the microporous membrane 20 is hydrophilic while the remainder of the microporous membrane 20 is hydrophobic. As will be described below, the microporous membrane 20 can be treated in any number of ways to render the first side 21 hydrophilic.

A first method of treating the microporous membrane 20 can now be described. The first method of treating the microporous membrane 20 can include a first step of pre-treating the microporous membrane 20 with energetic sources followed by a second step of coating the microporous membrane 20 with hydrophilic moieties. Initially, the microporous membrane 20 may be substantially or completely hydrophobic. In the first step, the first side 21 of the microporous membrane 20 can initially be pre-treated with energetic sources. These energetic sources include, but are not limited to, radio-frequency glow discharge plasma, low pressure microwave discharge, ozone, etc. In a further example, the first side 21 of the microporous membrane 20 can be exposed with H₂ plasma in a range of about 50 watts to about 150 watts. Treating the microporous membrane 20 with these energetic sources can cleave relatively strong carbon-fluorine bonds in the microporous membrane 20, thus generating free radicals.

After the first step of pre-treating the microporous membrane 20 with energetic sources, the microporous membrane 20 can further be treated with hydrophilic moieties in the second step. In particular, after pre-treating the first side 21 of the microporous membrane 20 with the energetic sources, the first side 21 is then treated with the hydrophilic moieties. The hydrophilic moieties can be grafted to the free radicals of the microporous membrane 20 to form covalent bonds. In one example, the hydrophilic moieties can include a glycidyl-pendant group including, but not limited to, polyethylene-glycol methacrylate (5%-25% in aqueous solution). The glycidyl pendant group can be reacted to the plasma-treated substrate at about 50° C. to about 70° C. for about 4 hours to about 7 hours. After this treatment with hydrophilic moieties, the first side 21 of the microporous membrane 20 is rendered hydrophilic and forms the hydrophilic layer 30. The second side 21 of the microporous membrane 20 remains hydrophobic and includes the hydrophobic layer 32.

It is to be appreciated that the microporous membrane 20 is not limited to the first treatment method described above. In particular, the microporous membrane 20 is not limited to the above described first method for rendering a portion of the microporous membrane 20 hydrophilic. Instead, a second method of treating the microporous membrane 20 can now be described.

In the second method, the above mentioned steps of rendering the microporous membrane 20 hydrophilic (e.g., first pre-treating with energetic sources followed by grafting of hydrophilic moieties) can be reversed. For example, the microporous membrane 20 can initially be coated with the hydrophilic moieties. In particular, the first side 21 of the microporous membrane 20 can be coated and/or deposited with the hydrophilic moieties. In this example, a solvent including water and alcohol, such as isopropyl alcohol, is provided. The water to alcohol volume ratio can be such that a target solution surface tension is in a range of about 30 dynes/centimeter to about 50 dynes/centimeter. Hydrophilic moieties can be provided in the solvent. The hydrophilic moieties in the solvent can include, but are not limited to, polyvinyl-alcohol coupled with methacrylate side chains.

After the first step of coating the first side 21 of the microporous membrane 20 with the hydrophilic moieties, the first side 21 can then be exposed with the energetic treatment sources. In one example, the first side 21 is exposed to the energetic treatment sources to induce radical formation and covalent attachment of the hydrophilic moieties to the backbone of the microporous membrane 20. The energetic treatment sources include, in one example, e-beaming at a dosage in a range of about 5 kiloGray (kGy) to about 15 kGy. Of course, it is to be appreciated that any number of different energetic treatment sources are envisioned. For instance, the energetic treatment sources can be similar or identical to the energetic treatment sources described above. In particular, the energetic treatment sources can include, but are not limited to, radio-frequency glow discharge plasma, low pressure microwave discharge, ozone, etc. In a further example, the first side 21 of the microporous membrane 20 can be exposed with H₂ plasma in a range of about 50 watts to about 150 watts.

After the microporous membrane 20 has been treated with either the first method or second method (e.g., treating the microporous membrane 20 with energetic sources and coating the microporous membrane 20 with the hydrophilic moieties in either order), the first side 21 of the microporous membrane 20 is rendered hydrophilic while the second side 22 of the microporous membrane 20 remains hydrophobic. As such, the hydrophilic layer 30 is disposed on the first side 21 of the microporous membrane 20 while the hydrophobic layer 32 is disposed on the second side 22 of the microporous membrane 20.

It is to be appreciated that the present invention is not limited to the aforementioned methods for rendering a portion of the microporous membrane 20 hydrophilic. Instead, nearly any type of method, some of which may be generally known, can be used to form the hydrophilic layer 30 at the first side 21 of the microporous membrane 20.

The hydrophilic layer 30 and hydrophobic layer 32 shown in FIG. 2 are not limited to the dimensions as shown. In further examples, the hydrophilic layer 30 and/or hydrophobic layer 32 could each be wider or narrower than as shown in FIG. 2. In one possible example, the hydrophilic layer 30 can include about 10% of the entire thickness of the microporous membrane 20 (i.e., thickness of the hydrophilic layer 30 plus thickness of the hydrophobic layer 32), such that the hydrophilic layer 30 comprises about 10% of the microporous membrane 20 thickness while the hydrophobic layer 32 comprises the remaining 90% of the microporous membrane 20 thickness. In another example, the thickness of the hydrophilic layer 30 can be about 0.025 millimeters (0.001 inches) while the thickness of the microporous membrane 20 can be in a range of about 0.20 millimeters (0.008 inches) to about 0.23 millimeters (0.009 inches). Of course, other relative thicknesses of each of the hydrophilic layer 30 and hydrophobic layer 32 are contemplated. In particular, the aforementioned methods can be altered so as to change the relative dimensions of the hydrophilic layer 30 and hydrophobic layer 32.

As shown in FIG. 2, the microporous membrane 20 is vapor permeable. This vapor permeability feature is somewhat schematically depicted as a diffusion path 27. By providing the microporous membrane 20 as an asymmetric membrane having the hydrophilic layer 30 at the first side 21 and the hydrophobic layer 32 at the second side 22, the moisture vapor transmission rate (MVTR) through the microporous membrane 20 is increased. In particular, the rate of diffusion of vapor along the diffusion path 27 is increased, such that the MVTR from the first side 21 to the second side 22 of the microporous membrane 20 is increased. This is due, at least in part, to changing a surface energy of the microporous membrane 20 from a low surface energy of hydrophobic material to a relatively high surface energy at the hydrophilic layer 30. As such, when the non-distilled liquid 14 is supplied to the hydrophilic layer 30 of the microporous membrane 20, the first side 21 can at least partially wet out with the non-distilled liquid 14, such as by wetting out the surface of the first side 21. The non-distilled liquid 14 can then evaporate within the hydrophilic layer 30 and pass through the microporous membrane 20.

Because the first side 21 of the microporous membrane 20 has been rendered hydrophilic and includes the hydrophilic layer 30, a diffusion path length of the vapor through the microporous membrane 20 is decreased. In particular, the diffusion path length of the vapor may be defined as a distance that the vapor from the non-distilled liquid 14 travels through the microporous membrane 20. Further, the thickness of the hydrophobic layer 32 is less than a total thickness of the microporous membrane 20 (e.g., distance from the first side 21 to the second side 22). As such, since the non-distilled liquid 14 at least partially wets the surface of the first side 21 and may permeate at least partially into the hydrophilic layer 30, the diffusion path length of the vapor through the hydrophobic layer 32 is less than a total thickness of the microporous membrane 20. Therefore, this reduced diffusion path length of the vapor leads to an increased MVTR since the vapor will travel a shorter distance through the microporous membrane 20 as compared to a membrane that is entirely hydrophobic and does not include a hydrophilic layer.

Additionally, by rendering the first side 21 of the microporous membrane 20 hydrophilic, the microporous membrane 20 can exhibit an increased resistance to fouling and/or particulate buildup. For example, the surface of the hydrophilic layer 30 at the first side 21 will at least partially wet out with the non-distilled liquid 14. Since the non-distilled liquid 14 wets out the first side 21 (e.g., see buildup of the non-distilled liquid 14 in FIG. 2), the non-distilled liquid 14 can at least partially protect the first side 21 from exposure to particulates, bacteria, and other materials that may normally foul the first side 21.

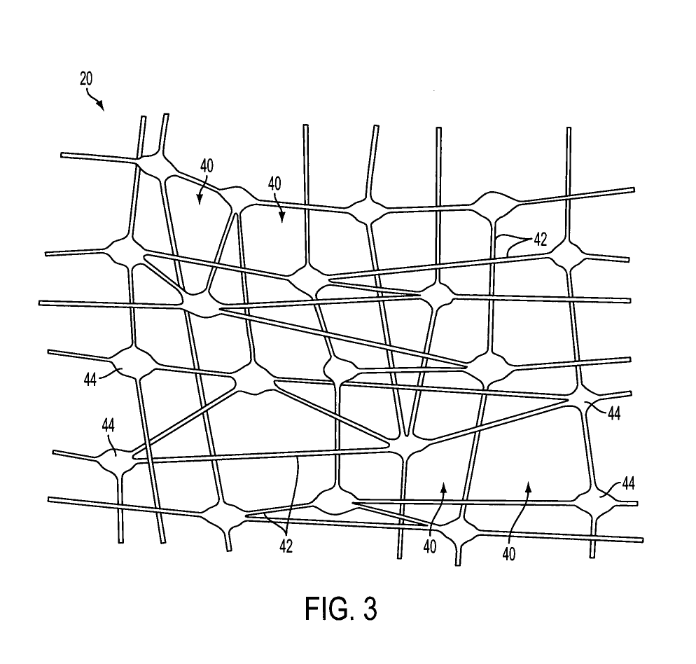

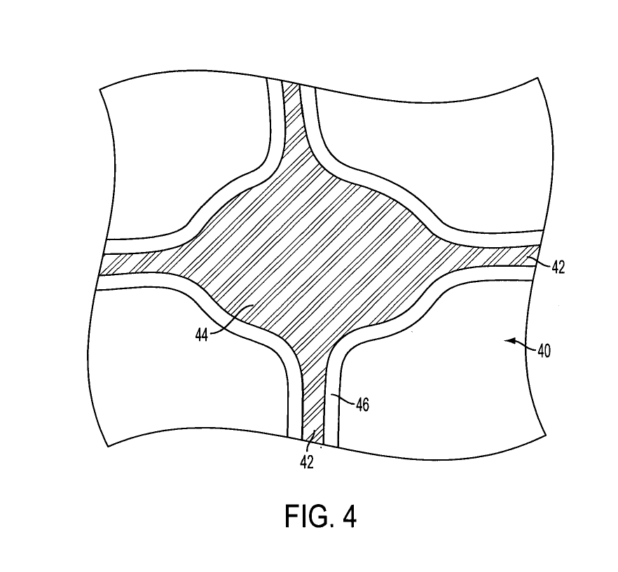

Referring now to FIG. 3, the structure and porosity of the microporous membrane 20 in FIG. 2 can be seen more clearly. In this example, the microporous membrane 20 can include an ePTFE membrane. The microporous membrane 20 includes a network of fibrils 42 and nodes 44 that create a plurality of pores 40. The plurality of pores 40 extends completely through the microporous membrane 20 between the first side 21 and second side 22. The size of the pores 40 is not limited to the example shown, and can vary based on the type of microporous membrane 20 being used. In further examples, the pore size of the hydrophilic layer 30 can be slightly smaller than a pore size of the hydrophobic layer 32. In such an example, the pore size of the hydrophilic layer 30 can be in a range of about 5% to 10% less than the pore size of the hydrophobic layer 32.

The microporous membrane 20 can act as a barrier to liquids while providing a relatively high diffusion rate for vapor. Thus, the pores 40 can be large enough to allow vapor to pass through the microporous membrane 20, but small enough to block the flow of liquid droplets and/or particulates through the microporous membrane 20. Accordingly, if a liquid were to come in direct contact with the microporous membrane 20 and its pores 40, the water would “foul”, or clog, the pores 40 it came in contact with due to the inability of the liquid to pass through the pores 40. However, because the microporous membrane 20 includes the hydrophobic layer 32, which acts as a vapor permeable—liquid impermeable barrier, the non-distilled liquid 14 is limited and/or prevented from being retained on the microporous membrane 20 and entering the pores 40, thus keeping the pores 40 open for the transfer of vapor across the microporous membrane 20.

Referring now to FIG. 4, a further enlarged view of the hydrophilic layer 30 of the microporous membrane 20 of FIG. 3 is shown. In this example, the hydrophilic layer 30 includes a hydrophilic moiety coating 46 at the fibril 42 and node 44 level. In particular, the hydrophilic moiety coating 46 is adhered to both of the fibrils 42 and nodes 44. The hydrophilic moiety coating 46 can cover and/or completely encompass the fibrils 42 and nodes 44, including portions of the fibrils 42 and nodes 44 forming the walls defining the pores 40. In one example, the hydrophilic moiety coating 46 can be of a certain thickness such that the pores 40 are still open for gas and/or vapor permeability. As such, a relatively thin and even hydrophilic moiety coating 46 is applied to the first side 21 of the microporous membrane 20. It is to be appreciated that when applied, the hydrophilic moiety coating 46 may at least partially penetrate the material of the fibrils 42 and nodes 44, while some of the hydrophilic moiety coating 46 may remain on the surface of the fibrils 42 and nodes 44. As such, the thickness of the hydrophilic moiety coating 46 applied to the microporous membrane 20 may vary but, in one example, may not exceed the thickness of the fibrils 42 and nodes 44 themselves.

An example method of operating the membrane distillation system 10 using the microporous membrane 20 can now be described in detail. Initially, the heat generating means 12 can heat and/or maintain the non-distilled liquid 14 at a relatively high temperature. The heat generating means 12 can include waste heat, low grade heat, or the like. The membrane distillation system 10 can further include the cooling means 28 for maintaining the distilled liquid 26 at a lower temperature than the non-distilled liquid 14. Next, the supply means 16 can supply the heated non-distilled liquid 14 to the microporous membrane 20. In particular, the supply means 16 supplies the non-distilled liquid 14 to the first side 21 of the microporous membrane 20. The non-distilled liquid 14 can at least partially wet out the hydrophilic layer 30 at the first side 21 and evaporate. Due to the temperature gradient between the first side 21 and second side 22 of the microporous membrane 20, vapor from the non-distilled liquid 14 is driven to permeate through the hydrophobic layer 32 and towards the second side 22. By providing the microporous membrane 20 as asymmetric with both the hydrophilic layer 30 and the hydrophobic layer, the MVTR is increased, thus improving the efficiency of the membrane distillation system 10 by allowing for more liquid to be distilled at a faster rate. The vapor can travel along the diffusion path 27 and will condense into the distilled liquid 26 at the second side 22. The distilled liquid 26 can then be collected by the collection means 24.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A membrane distillation system for distilling liquids, the membrane distillation system including:
a heat generating means for heating a non-distilled liquid;
a microporous membrane that is asymmetric and vapor permeable, the microporous membrane including a hydrophilic layer and a hydrophobic layer;
a supply means for delivering the heated non-distilled liquid to the hydrophilic layer of the microporous membrane; and
a collection means for collecting distilled liquid from the hydrophobic layer of the microporous membrane.

2. The membrane distillation system of claim 1, wherein the hydrophilic layer is provided at a first side of the microporous membrane and the hydrophobic layer is provided at an opposing second side of the microporous membrane, the first side of the microporous membrane being asymmetric with respect to the second side of the microporous membrane.

3. The membrane distillation system of claim 2, wherein the hydrophilic layer includes a pore size that is in a range of about 5% to 10% less than a pore size of the hydrophobic layer.

4. The membrane distillation system of claim 2, wherein the first side of the microporous membrane is configured to be treated with energetic sources.

5. The membrane distillation system of claim 4, wherein the energetic sources include at least one of radio-frequency glow discharge plasma and microwave discharge.

6. The membrane distillation system of claim 2, further including a hydrophilic moiety coating applied to the first side of the microporous membrane.

7. The membrane distillation system of claim 6, wherein the hydrophilic moiety coating includes at least one of a glicydyl functional group, acrylic acid functional group, acrylate functional group, and acrylamide functional group.

8. The membrane distillation system of claim 1, wherein the microporous membrane is selected from a group including expanded polytetrafluoroethylene, polytetrafluoroethylene, polyvinylidene fluoride, and polypropylene.

9. The membrane distillation system of claim 1, wherein a diffusion path length of vapor from the non-distilled liquid and through the hydrophobic layer is less than a thickness of the microporous membrane.

10. The membrane distillation system of claim 1, wherein the hydrophilic layer is provided at a first side of the microporous membrane and the hydrophobic layer is provided at an opposing second side of the microporous membrane, further wherein a temperature differential across the microporous membrane is configured to cause the non-distilled liquid to evaporate from the first side, pass through the hydrophilic layer and the hydrophobic layer, and condense at the second side.

11. The membrane distillation system of claim 10, wherein a temperature of the non-distilled liquid at the hydrophilic layer is higher than a temperature of the distilled liquid at the hydrophobic layer.

12. A microporous membrane that is vapor permeable for distilling liquids, the microporous membrane including:
a hydrophilic layer provided at a first side of the microporous membrane; and
a hydrophobic layer provided at an opposing second side of the microporous membrane, wherein the first side of the microporous membrane is asymmetric with respect to the second side of the microporous membrane.

13. The microporous membrane of claim 12, wherein the first side of the microporous membrane is configured to be treated with energetic sources.

14. The microporous membrane of claim 13, wherein the energetic sources include at least one of a radio-frequency glow discharge plasma and a microwave discharge.

15. The microporous membrane of claim 12, further including a hydrophilic moiety coating applied to the first side of the microporous membrane.

16. The microporous membrane of claim 15, wherein the hydrophilic moiety coating includes at least one of a glicydyl functional group, acrylic acid functional group, acrylate functional group, and acrylamide functional group.

17. A method of fabricating a microporous membrane that is vapor permeable for use in a membrane distillation system, the method including the steps of:
providing a hydrophobic microporous membrane; and
treating a first side of the hydrophobic microporous membrane with energetic sources and coating the first side with hydrophilic moieties to covalently bond the hydrophilic moieties to the first side such that the first side of the hydrophobic microporous membrane is hydrophilic and a second side is hydrophobic.

18. The method of claim 17, wherein the hydrophobic microporous membrane is selected from a group including expanded polytetrafluoroethylene, polytetrafluoroethylene, polyvinylidene fluoride, and polypropylene.

19. The method of claim 17, wherein the energetic sources include at least one of a radio-frequency discharge plasma and a microwave discharge.

20. The method of claim 17, wherein the hydrophilic moieties include at least one of a glicydyl functional group, acrylic acid functional group, acrylate functional group, and acrylamide functional group.
